(19) United States
(12) Patent Application Publication
(10) Pub. No.: US 2026/0106445 A1
(43) Pub. Date: Apr. 16, 2026

(54) ELECTRONIC FUSE DEVICE

(71) Applicant: HELLA GMBH & CO. KGAA, Lippstadt (DE)

(72) Inventors: Christopher Lankeit, Paderborn (DE); Michel Moutarde, Savenès (FR)

(21) Appl. No.: 19/353,111

(22) Filed: Oct. 8, 2025

(30) Foreign Application Priority Data
Oct. 11, 2024 (DE) 102024129449.3

(51) Int. Cl. H02H 3/08

(52) U.S. Cl. CPC H02H 3/08

(57) ABSTRACT

The present invention relates to an electronic fuse device. The electronic fuse device includes: a semiconductor switch, a load current detecting device, and a load current monitoring unit. The load current detecting device is configured to detect a load current flowing through the semiconductor switch and is configured to provide a corresponding load current signal. The load current monitoring unit, to which the load current signal is provided, is configured to evaluate the load current signal by means of an evaluation procedure. The load current monitoring unit is configured to execute the evaluation procedure only if at least one test parameter exceeds an associated threshold value.

### CROSS-REFERENCE TO RELATED APPLICATIONS

The present application claims the benefit of German Patent Application 10-2024-129-449.3, filed Oct. 11, 2024, the disclosure of which is incorporated by reference.

### BACKGROUND OF THE INVENTION

The present invention relates to an electronic fuse device comprising: a semiconductor switch, a load current detecting device which is configured to detect a load current flowing through the semiconductor switch and to provide a corresponding load current signal, and a load current monitoring unit to which the load current signal is provided and which is configured to evaluate the load current signal by means of an evaluation procedure.

Such an electronic fuse device is known, for example, from U.S. Pat. No. 11,611,205 B2. The present invention is based on the object of realizing a resource-saving electronic fuse device.

### SUMMARY OF THE INVENTION

According to the invention, the foregoing object is achieved by an electronic fuse device as set forth herein. The electronic fuse device according to the invention includes at least one semiconductor switch which is designed to be connected on the input side to an electrical power source, in particular a motor vehicle battery and/or a motor vehicle DC/DC converter, and on the output side to an electrical load to be fused. The semiconductor switch is preferably a so-called power semiconductor switch. Preferably, the semiconductor switch comprises at least one, preferably several so-called MOSFETs (metal-oxide-semiconductor field-effect transistors) connected electrically in parallel. However, it is also conceivable that the semiconductor switch comprises one or more so-called IGBTs (insulated gate bipolar transistors), one or more JFETs (junction field effect transistors), one or more BJTs (bipolar junction transistors) or one or more HEMTs (high electron mobility transistors).

The electronic fuse device further comprises a load current detecting device, which is configured in a known manner to detect a load current flowing through the semiconductor switch, in particular through a so-called load current path of the semiconductor switch, and to provide a corresponding load current signal. The load current detecting device can, for example, comprise a measuring resistor and a differential amplifier connected to the input and output of the measuring resistor. Preferably, the load current detecting device is configured to output an analog load current signal. However, it is also conceivable in principle that the load current detecting device comprises an analog-to-digital converter for generating a digital load current signal.

The electronic fuse device further comprises a load current monitoring unit to which the load current signal is provided and which is configured to evaluate the load current signal by means of an evaluation procedure. The load current monitoring unit comprises a computer system in which the evaluation procedure is stored as a computer program. The evaluation procedure is designed in a known manner to determine, by evaluating the load current signal, whether or not the specified conditions for triggering the electronic fuse, i.e. for interrupting the power supply by activating the semiconductor switch accordingly, are present.

Since executing the evaluation procedure is relatively computing power-intensive and memory-intensive, the load current monitoring unit according to the invention is configured to compare at least one test parameter with an associated threshold value and to execute the evaluation procedure only if at least one test parameter exceeds the associated threshold value. In principle, it is conceivable that one or more test parameters are determined by the load current monitoring unit, for example based on the load current signal or another measurement signal provided, or that one or more test parameters are provided to the load current monitoring unit, for example by a higher-level control unit.

Consequently, the load current monitoring unit configured according to the invention avoids unnecessary execution of the evaluation procedure, whereby a resource-saving electronic fuse device can be realized.

In principle, the load current monitoring unit can comprise any type of computer system. In a preferred embodiment, however, the load current monitoring unit comprises a microcontroller or the load current monitoring unit is formed by a microcontroller. Microcontrollers are inexpensive standard components that can be programmed easily and in a variety of ways. Furthermore, microcontrollers typically comprise at least one analog-to-digital converter and are therefore suitable for receiving and processing an analog load current signal or other analog measurement signals.

Preferably, the load current monitoring unit is configured to determine a test parameter based on the load current signal. Preferably, the test parameter determined based on the load current signal is used to indicate or estimate a load current currently flowing through the semiconductor switch. The test parameter can, for example, indicate a current amplitude or a current magnitude of the load current signal. However, it is also conceivable that the test parameter indicates a rate of change or another parameter indicating or estimating the extent of a change in the load current signal.

In a preferred embodiment, a temperature signal is additionally provided to the load current monitoring unit, and the load current monitoring unit is configured to determine a test parameter based on the temperature signal. The temperature signal can be an analog signal or a digital signal, wherein a digital temperature signal preferably provides the test parameter directly to the load current monitoring unit. The temperature signal can be provided to the load current monitoring unit directly by a temperature detecting device, or can be provided to the load current monitoring unit by a data processing unit or control unit. The temperature signal can, for example, indicate or estimate the temperature at an electrical load to be fused by the electronic fuse device. However, the temperature signal can also indicate or estimate the temperature of a component of the electronic fuse device itself, for example the semiconductor switch.

In a further preferred embodiment, the load current monitoring unit is additionally provided with a voltage signal, and the load current monitoring unit is configured to determine a test parameter based on the voltage signal. The voltage signal can be an analog signal or a digital signal, wherein a digital voltage signal preferably provides the test parameter directly to the load current monitoring unit. The voltage signal can be provided to the load current monitoring unit directly by a voltage detecting device, or can be provided to the load current monitoring unit by a data processing unit or control unit. The voltage signal can, for example, indicate or estimate the electrical voltage at an electrical load to be fused by the electronic fuse device. However, the voltage signal can also indicate or estimate the electrical voltage at a component of the electronic fuse device itself, for example at a connection of the semiconductor switch. The test parameter determined based on the voltage signal can, for example, indicate a current amplitude or a current magnitude of the voltage signal. However, it is also conceivable that the test parameter determined based on the voltage signal indicates a rate of change or another parameter indicating or estimating the extent of a change in the voltage signal.

In a further preferred embodiment, the load current monitoring unit is additionally provided with a trigger signal, and the load current monitoring unit is configured to determine a test parameter based on the trigger signal. Preferably, the triggering signal is designed to transmit a triggering information that can only have two states, namely a triggering state or a non-triggering state. Here, the trigger state indicates that the evaluation procedure should be triggered and the non-trigger state indicates that the evaluation procedure should not be triggered. Consequently, the trigger state corresponds to a test parameter determined based on the trigger signal that is greater than the associated threshold value, and the non-trigger state corresponds to a test parameter determined based on the trigger signal that is less than the associated threshold value. The test parameter determined based on the trigger signal therefore preferably indicates directly whether carrying out the evaluation procedure should be triggered or not. The trigger signal can, for example, be provided by a higher-level data processing unit or control unit. The trigger signal can be an analog signal, which can, for example, assume a high and a low voltage level, or can be a digital signal, which preferably provides the test parameter directly to the load current monitoring unit.

### BRIEF DESCRIPTION OF THE DRAWING

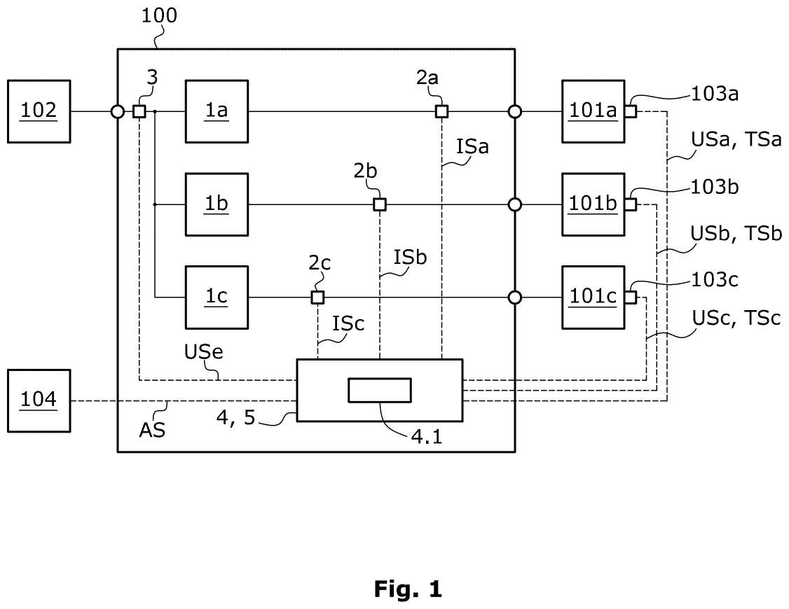

An exemplary embodiment of the present invention is described below with reference to the accompanying FIG. 1, which shows a schematic diagram of an electronic fuse device according to the invention.

### DETAILED DESCRIPTION OF THE CURRENT EMBODIMENTS

FIG. 1 shows an electronic fuse device 100 according to the invention, which in the present exemplary embodiment comprises three semiconductor switches 1a, 1b, 1c and is thus designed in the present exemplary embodiment to fuse three electrical loads 101a, 101b, 101c, wherein the electronic fuse device 100 could in principle also have any other number of semiconductor switches for fusing a corresponding number of electrical loads.

All three semiconductor switches 1a, 1b, 1c are each electrically connected on the input side to an electrical power source 102.

The first semiconductor switch 1a is electrically connected on the output side to the first load 101a, the second semiconductor switch 1b is electrically connected on the output side to the second load 101b, and the third semiconductor switch 1c is electrically connected on the output side to the third load 101c.

A detecting device 103a, 103b, 103c is arranged on each load 101a, 101b, 101c, which is configured to detect an electrical voltage applied to the respective load 101a, 101b, 101c and a temperature of the respective load 101a, 101b, 101c and to provide a corresponding voltage signal USa, USb, USc and a corresponding temperature signal TSa, TSb, TSc.

The electronic fuse device 100 comprises three load current detecting devices 2a, 2b, 2c, each of which is configured to detect a load current flowing through the respective semiconductor switch 1a, 1b, 1c during operation and to provide a corresponding load current signal ISa, ISb, ISc.

The electronic fuse device 100 comprises an input voltage detecting device 3 which is configured to detect an input voltage applied at the inputs of the three semiconductor switches 1a, 1b, 1c and to provide a corresponding voltage signal USe.

The electronic fuse device 100 comprises a current monitoring unit 4, which in the present exemplary embodiment is formed by a microcontroller 5.

The current monitoring unit 4 is provided with the load current signals ISa, ISb, ISc of all load current detecting devices 2a, 2b, 2c, the voltage signals USa, USb, USc and the temperature signals TSa, TSb, TSc of all detecting devices 103a, 103b, 103c, and the voltage signal USe of the input voltage detecting device 3.

The current monitoring unit 4 is further provided with a trigger signal AS from a control unit 104 that is higher-level than the electronic fuse device 100.

The current monitoring unit 4 is configured to determine a test parameter based on the load current signals ISa, ISb, ISc, the voltage signals USa, USb, USc, USe, the temperature signals TSa, TSb, TSc and the trigger signal AS and to compare the determined test parameters with an individual associated threshold value programmed into the microcontroller 5 in the present exemplary embodiment.

The current monitoring unit 4 is further configured to evaluate the load current signals ISa, ISb, ISc by means of an evaluation procedure 4.1 programmed into the microcontroller 5 in the present exemplary embodiment in order to determine whether the respective semiconductor switch 1a, 1b, 1c is to be activated to interrupt the power supply to the respective load 101a, 101b, 101c.

The current monitoring unit 4 is configured to execute the evaluation procedure 4.1 only if one of the test parameters determined by the current monitoring unit 4 exceeds the associated threshold value.

### LIST OF REFERENCE SYMBOLS

100 electronic fuse device
1a, 1b, 1c semiconductor switch
2a, 2b, 2c load current detecting devices
3 input voltage detecting device
4 monitoring unit
4.1 evaluation procedure
5 microcontroller
101a, 101b, 101c loads
102 power source
103a, 103b, 103c detecting devices
104 control unit
AS trigger signal
ISa, ISb, ISc load current signals
TSa, TSb, TSc temperature signals
USa, USb, USc, USe voltage signals

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An electronic fuse device comprising:
a semiconductor switch; and
a load current detecting device which is configured to detect a load current flowing through the semiconductor switch and to provide a corresponding load current signal; and
a load current monitoring unit to which the load current signal is provided and which is configured to evaluate the load current signal via an evaluation procedure, wherein the load current monitoring unit is configured to execute the evaluation procedure only if at least one test parameter exceeds an associated threshold value.

2. The electronic fuse device of claim 1, wherein the load current monitoring unit includes a microcontroller.

3. The electronic fuse device of claim 1, wherein the load current monitoring unit is configured to determine the at least one test parameter based on the load current signal.

4. The electronic fuse device of claim 1, wherein a temperature signal is additionally provided to the load current monitoring unit, and wherein the load current monitoring unit is configured to determine the at least one test parameter based on the temperature signal.

5. The electronic fuse device of claim 1, wherein a voltage signal is additionally provided to the load current monitoring unit, and wherein the load current monitoring unit is configured to determine the at least one test parameter based on the voltage signal.

6. The electronic fuse device of claim 1, wherein a trigger signal is additionally provided to the load current monitoring unit, and wherein the load current monitoring unit is configured to determine the at least one test parameter based on the trigger signal.
